(19) United States
(12) Patent Application Publication
(10) Pub. No.: US 2010/0173095 A1
(43) Pub. Date: Jul. 8, 2010

(54) Inkjet ink and method for making conductive wires using the same

(75) Inventors: Yao-Wen Bai, BeiJing (CN); Qiu-Yue Zhang, BeiJing (CN); Cheng-Hsien Lin, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: Tsinghua University, Beijing (CN); HON HAI PRECISION INDUSTRY CO., LTD., Tu-Cheng (TW)

(21) Appl. No.: 12/589,461

(22) Filed: Oct. 22, 2009

(30) Foreign Application Priority Data
Jan. 7, 2009 (CN) 200910104952.7

(51) Int. Cl. B05D 5/12; H01B 1/04; C23C 28/00

(52) U.S. Cl. 427/551; 252/503; 427/117; 205/184; 427/553; 977/742; 977/932

(57) ABSTRACT

An inkjet ink includes a solvent, precious metal ions, a number of carbon nanotubes, and a binder. The carbon nanotubes are disposed in the solvent, and the precious metal ions are adhered to a surface of each of the carbon nanotubes via the binder. A method for making conductive wires is provided.

### RELATED APPLICATIONS

This application is related to commonly-assigned applications entitled, “METHOD FOR MAKING CONDUCTIVE WIRES”, filed ______ (Atty. Docket No. US21886); “METHOD FOR MAKING CARBON NANOTUB COMPOSITE”, filed ______ (Atty. Docket No. US24701).

### BACKGROUND

1. Technical Field

The present disclosure relates to inkjet ink and method for making conductive wires using the ink, and particularly, to inkjet ink containing carbon nanotubes and a method for making conductive wires using the same.

2. Description of Related Art

Recent advancements in the field of inkjet printing include making an interconnection wire using the inkjet printing process of.

Inkjet printing is a non-impact printing process in which droplets of inkjet ink are deposited on a substrate to form the desired image. The droplets are ejected from a print head in response to digital signals generated by a microprocessor. Inkjet printing can be especially advantageous for making unique prints or small lots because, as a digital technology, images can be easily changed or varied.

There has been much interest recently in using inkjet printing techniques in electronics manufacturing and particularly printing conductive metal patterns. A typical example is disclosed and discussed in U.S. Publication No. 2006/0189113A1, entitled, “METAL NANOPARTICLE COMPOSITIONS”, published to Karel Vanheusden et al. on Aug. 24, 2006. This publication discloses a composition for inkjet printing and methods for forming a conductive feature on a substrate involving inkjet printing.

Another example is shown and discussed in U.S. Publication No. 2006/0130700A1, entitled, “SILVER-CONTAINING INKJET INK”, published to Nicole M. Relnartz on Jun. 22, 2006. This publication discloses an inkjet ink comprising silver salt and a method for the fabrication of a conductive feature on a substrate. The method includes disposing an inkjet ink comprising silver salt on a substrate to form a feature and disposing a second inkjet ink on the substrate. The second inkjet ink includes a reducing agent capable of reducing silver salt to silver metal. However, the method for making a conductive feature on a substrate in U.S. Publication No. 2006/0130700A1 has the following disadvantages. The use of the reducing agent makes the process more complicated and costly. Furthermore, the prepared conductive lines are made up of silver particle interconnected structures via the reduction of silver ions, and a nonuniform distribution of the silver particles. Therefore, the thickness of the formation of conductive lines varies, and the conductive lines have poor conductivity.

Another example is shown and discussed in TW Publication No. 298520, entitled, “Method of making an electroplated interconnection wire of a composite of metal and carbon nanotubes”, published on Jul. 1, 2008. This publication discloses a method for making interconnection wires. The method includes preparing a dispersion of carbon nanotubes dispersed in an organic solvent, printing a baseline with the dispersion on a surface of a substrate, evaporating the organic solvent to obtain a conductive baseline, and electroplating the surface in an electroplating bath containing metal ions, so that an electroplated interconnection wire of a composite of the metal and carbon nanotubes is formed on the conductive baseline.

However, the method for making interconnection wires by printing and electroplating has the following disadvantages. A mass ratio of the carbon nanotubes in the dispersion solvent used in this method is large, usually above 10%, to ensure formation of a conductive baseline for the electroplating. Such a large mass ratio means the carbon nanotubes cannot be uniformly dispersed in the solvent, thus the thickness of the interconnection wires is nonuniform. Furthermore, current density in the conductive baseline will be nonuniform during electroplating which further contributes to nonuniform thicknesses of the interconnection wires.

What is needed, therefore, is to provide an inkjet ink and a method for making conductive wires having improved uniformity of thickness.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments.

FIG. 1 is a flow chart of one embodiment of a method for making conductive wires.

FIG. 2 is a schematic view of one embodiment of the steps in the method for making conductive wires.

### DETAILED DESCRIPTION

The present disclosure provides an inkjet ink. The inkjet ink includes precious metal ions, carbon nanotubes, a solvent, a viscosity modifier, a surfactant, and a binder. The weight percent (wt %) of the precious metal ions is in a range from about 1 wt % to about 55 wt %. The wt % of the carbon nanotubes is in a range from about 0.2 wt % to about 5 wt %. The wt % of the solvent is in a range from about 50 wt % to about 80 wt %. The wt % of the viscosity modifier is in a range from about 0.1 wt % to about 30 wt %. The wt % of the surfactant is in a range from about 0.1 wt % to about 5 wt %. The wt % of the binder is in a range from about 0.1 wt % to about 30 wt %.

The precious metal ions can be gold ions (Au⁺), silver ions (Ag⁺), palladium ions (Pd⁺), or platinum ions (Pt⁺). In the present embodiment, the precious metal ions are silver ions. Silver nitrate can be directly mixed with water to obtain a solution with silver ions.

The solvent can be water. In the present embodiment, the solvent is de-ionized water.

The binder can be polyvinyl pyrrolidones (PVP), polyvinyl alcohols (PVA), polyethyleneimine (PEI), or combinations thereof. The binder can fix the carbon nanotubes on a substrate after the solvent is evaporated. In the present embodiment, the binder is PVP.

The binder can combine the precious metals ions (such as Au⁺, Ag⁺, Pt⁺ or Pd⁺) in the ink to generate a complex. The complex can be entangled with the surface of carbon nanotubes. Therefore the precious metal ions are adhered to a surface of each of the carbon nanotubes via the binder. The binder can also bind the carbon nanotubes with the precious metal ions to the surface of the substrate. The binding force between the inkjet ink and the substrate can also be increased by increasing the weight percentage of the binders in the inkjet ink.

The wt % of the carbon nanotubes in the inkjet ink cannot be too high. Otherwise, the carbon nanotubes cannot be uniformly dispersed in the ink, which may plug the inkjet printer nozzle. The wt % of carbon nanotubes in the ink is in a range from about 0.2 wt % to about 5 wt %. The carbon nanotubes are substantially dispersed in the inkjet ink. Specifically, each carbon nanotube is substantially separated from the other carbon nanotubes and is not part of a “bundle”. The carbon nanotubes in the inkjet ink are separate entities and are free of strong interaction between each other. The carbon nanotubes are also substantially uniformly distributed throughout the inkjet ink. Therefore, the carbon nanotubes in the inkjet ink will not plug the inkjet printer nozzle.

The carbon nanotubes in the ink can be single-walled carbon nanotubes, double-walled carbon nanotubes, multi-walled carbon nanotubes, or combinations thereof. A diameter of each carbon nanotube can be less than about 50 nanometers. A length of the carbon nanotubes can be less than about 2 micrometers. In the present embodiment, the diameter of each carbon nanotube is less than about 50 nanometers. The length of the carbon nanotubes is in a range from about 50 nanometers to about 200 nanometers. The carbon nanotubes with the length and the diameter described above can be easily substantially dispersed, which will not plug the inkjet printer nozzle.

Furthermore, the carbon nanotubes can be chemically functionalized, which refers to carbon nanotubes being chemically treated to introduce functional groups on the surface. Chemical treatments include, but are not limited to, oxidation, radical initiation reactions, and Diels-Alder reactions. The functional groups can be any hydrophilic group, such as carboxyl (—COOH), aldehyde group (—CHO), amino (—NH₂), hydroxyl (—OH), or combinations thereof. The carbon nanotubes are soluble in the solvent by the provision of the functional groups.

The viscosity modifier can be a water-soluble polymer, such as methanol, ethanol, cellulose ethers, guar gum, silica gel or combinations thereof. In one embodiment, the viscosity modifier is cellulose ethers.

The surfactant can be fatty acids, phosphate esters, sodium lauryl sulfates, isosorbide dinitrates, modified polyvinyl alcohols (PVA), or combinations thereof The surfactant can help uniformly disperse the carbon nanotubes in the ink. In one embodiment, the surfactant is modified PVA.

The ink may further include a moisturizing agent of about 0.1 wt % to about 40 wt %. The moisturizing agent can be an agent with a high boiling point. The moisturizing agent can be polypropylene glycols (PPG), glycol ethers, and combinations thereof The moisturizing agent can raise the boiling point of the ink. The ink provided in the present embodiment is not volatilizable at temperatures less than 50° C. In one embodiment, the moisturizing agent is glycol ethers.

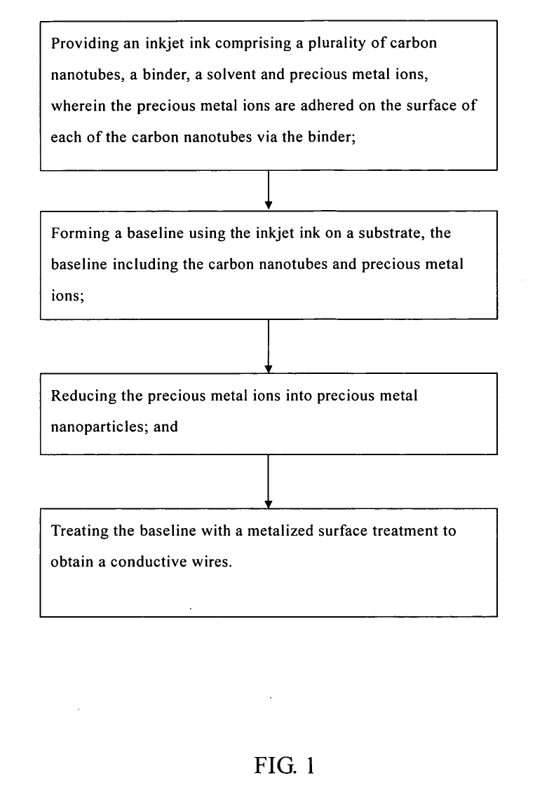

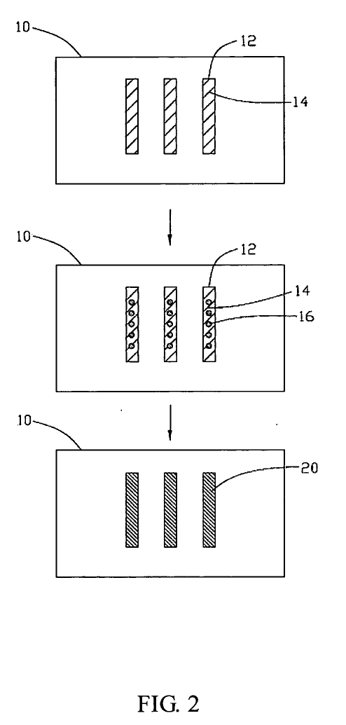

Referring to FIGS. 1 and 2, a method for making conductive wires 20 according to one embodiment includes:

(a) providing an inkjet ink comprising a plurality of carbon nanotubes 14, a binder, a solvent, and precious metal ions, wherein the precious metal ions are adhered on the surface of each of the carbon nanotubes 14 via the binder;

(b) forming a baseline 12 using the inkjet ink on a substrate 10, the baseline 12 including the carbon nanotubes 14 and precious metal ions;

(c) reducing the precious metal ions into precious metal nanoparticles 16; and

(d) treating the baseline 12 with a metalized surface treatment to obtain conductive wires 20.

In step (a), the inkjet ink can be made by:

(a1) providing a binder and a solvent containing precious metal ions to form a first mixture;

(a2) dispersing a plurality of carbon nanotubes 14 in the first mixture to form a second mixture; and

(a3) adding a viscosity modifier, a surfactant, and a binder into the second mixture to form a third mixture, and agitating the third mixture to obtain an inkjet ink.

The step (a1) includes:

(a11) providing a binder and dissolving the binder into water to form a binder solvent;

(a12) providing a precious metal ion solvent and adding the precious metal ion solvent into the binder solvent; and

(a13) agitating the solvent comprising the binder and precious metal ions for 10 minutes to 30 minutes to get the first mixture.

In step (a1), the binder can be PVP, PVA, PEI, or combinations thereof.

In step (a1), the binder and precious metal ions are combined into a complex compound. The molar concentration ratio of the precious metal ions and the binder is in a range from about 1:100 to about 1:3.

In step (a13), in one embodiment, the binder is PVP, the precious ions are Ag⁺; and silver nitrate is directly dissolved in water to obtain the solution with silver ions. The molar concentration ratio of the precious metal ions and the PVP is 1:5. The time of agitating is about 30 minutes.

The step (a2) includes (a21) providing a carbon nanotube solvent and (a22) adding the carbon nanotube solvent into the first mixture and agitating the solvent including the first mixture and the carbon nanotubes for 10 minutes to 30 minutes to get the second mixture.

The step (a21) includes:

(a211) providing and purifying a plurality of carbon nanotubes 14;

(a212) functionalizing the carbon nanotubes 14; and

(a213) dispersing the functionalized carbon nanotubes 14 in water.

In step (a211), the carbon nanotubes 14 can be obtained by any method, such as chemical vapor deposition (CVD), arc discharging, or laser ablation. In one embodiment, the carbon nanotubes 14 can be obtained by providing a substrate, forming a carbon nanotube array on the substrate by CVD, and peeling the carbon nanotube array off of the substrate by a mechanical method, thereby achieving a plurality of carbon nanotubes 14. The carbon nanotubes 14 in the carbon nanotube array are substantially parallel to each other.

The carbon nanotubes 14 can be purified by heating the carbon nanotubes 14 in air flow at about 350° C. for about 2 hours to remove amorphous carbons, soaking the treated carbon nanotubes 14 in about 36% hydrochloric acid for about one day to remove metal catalysts, isolating the carbon nanotubes soaked in the hydrochloric acid, rinsing the isolated carbon nanotubes 14 with de-ionized water, and filtrating the carbon nanotubes 14.

In step (a212), the carbon nanotubes 14 can be treated by an acid by, in one embodiment, refluxing the carbon nanotubes in nitric acid at about 130° C. for a period of time from about 4 hours to about 48 hours to form a suspension, centrifuging the suspension to form acid solution and carbon nanotube sediment, and rinsing the carbon nanotube sediment with water until the pH of the used water is about 7. The carbon nanotubes 14 can be chemically modified with functional groups such as —COOH, —CHO, —NH₂ and —OH on the walls and end portions thereof after the acid treatment. These functional groups can help carbon nanotubes 14 to be soluble and dispersible in the solvent.

In step (a213), the functionalized carbon nanotubes 14 can be treated by filtrating the carbon nanotubes, putting the carbon nanotubes 14 into de-ionized water to obtain a mixture, ultrasonically stirring the mixture, and centrifuging the mixture. The above steps are repeated about 4 to 5 times to obtain a solution of carbon nanotubes 14 and de-ionized water.

In step (a3), the third mixture of de-ionized water, carbon nanotubes, viscosity modifier, surfactant, and binder can be agitated mechanically for about 20 minutes to about 50 minutes at room temperature to obtain the inkjet ink. The inkjet ink can be sealed in an ink box. A moisturizing agent can be added in the third mixture in step (a3).

In step (b), the substrate 10 can be made of insulative material such as silicon, silicon oxide, quartz, sapphire, ceramic, glass, metal oxide, organic polymer, textile fabric, and combinations thereof. A shape and a size of the substrate 10 are arbitrary, and can be chosen according to need. The baseline 12 on the substrate 10 using the inkjet ink can be formed by printing using an inkjet printer. The baseline 12 includes a plurality of carbon nanotubes 14, binders, and precious ions. The precious ions are connected to the surfaces of the carbon nanotubes 14 by the binders.

In one embodiment, the substrate 10 is a polyimide laminate and the inkjet printer is an Epson R230. The inkjet print head will not get clogged because a length of the carbon nanotubes 14 is less than 200 nanometers and the ratio of carbon nanotubes 14 in the inkjet ink is less than or equal to 5% by weight. A pattern can be formed by a plurality of baselines 12 according to need. The width of the baselines 12 is in a range from about 10 microns to about 100 microns.

In step (c), the precious ions in the baseline 12 can be reduced to precious metal nanoparticles 16 disposed on the surfaces of the carbon nanotubes 14 via a reducing agent or radiation. The radiation source can be ultraviolet light, laser, or gamma ray. The precious metal ions can be reduced by a method of printing reducing agent on the baseline 12. The precious metal nanoparticles 16 are bound to the surface of carbon nanotubes 14 by the binder. The precious metal nanoparticles 16 are adsorbed to the surface of carbon nanotubes 14 and form a plurality of catalytic centers for chemical plating. The precious metal nanoparticles 16 are disposed uniformly on the surface of carbon nanotubes 14. The size of the precious metal nanoparticles 16 is in a range from about 10 nanometers to about 20 nanometers.

The binder in the inkjet ink also has the ability of reducing the precious metal ions. When radiated, a radical is shifted to the precious ions, so that the precious ions are reduced to precious metal nanoparticles 16. The precious metal nanoparticles 16 are bound to the surfaces of the carbon nanotubes 14, so that a conductive line can be formed on the substrate 10.

In one embodiment, the radiation is ultraviolet light. After radiating, the silver ions are reduced to silver nanoparticles, which are bound to the surfaces of the carbon nanotubes 14 by the binder.

Step (d) can include (d1) providing a chemical plating solution and (d2) applying the chemical plating solution on the baseline 12.

In step (d1), the chemical plating solution can be a nickel chemical plating solution or a copper chemical plating solution. In one embodiment, the chemical plating solution includes about 5 g/L to about 15 g/L of copper sulphate, about 10 mL/L to about 20 mL/L of formaldehyde, about 40 g/L to about 60 g/L of ethylene diamine tetraacetic acid (EDTA), about 15 g/L to about 30 g/L of potassium sodium tartrate.

In step (d2), the entire substrate 10 can be put into a chemical plating solution to apply a metal layer coating on the baseline 12. The baseline 12 can be immersed in copper chemical plating solution for about 2 minutes at a temperature of about 50° C. The precious metal nanoparticles 16 are adsorbed to the surfaces of the carbon nanotubes 14 and form a plurality of catalytic centers for chemical plating. Thus, the conductive wires 20 have great conductivity and uniform thickness.

The carbon nanotubes 14 can be uniformly dispersed in the inkjet ink because the ratio of the carbon nanotubes in the inkjet ink is less than or equal to 5% by weight and the carbon nanotubes 14 have a plurality of functional groups formed on the walls and end portions thereof. Thus, the thickness of the conductive wires 20 made by the chemical plating is uniform. In addition, the efficiency of chemical plating is increased due to the carbon nanotubes 14 in the baseline 12 having a large specific surface area and adsorbing a plurality of precious metal nanoparticles 16 thereon.

A step (e) of electroplating the conductive wires 20 can be carried out after step (d) to increase the thickness of conductive wires 20. In one embodiment, the conductive wires 20 are put into a copper electroplating bath for about 5 minutes to about 10 minutes to form a copper layer thereon. The thickness of the copper layer can range from about 10 micrometers to about 100 micrometers.

In step (d), the method of treating the baseline 12 can also be an electroplating method to obtain the conductive wires 20. The carbon nanotubes 14 in the baseline 12 have good conductivity, and the baseline 12 after step (c) includes a plurality of metal nanoparticles 16 adsorbed to the surfaces of the carbon nanotubes 14, to form the conductive wires 20.

Depending on the embodiment, certain of the steps described below may be removed, others may be added, and the sequence of steps may be altered. It is also to be understood that the above description and the claims drawn to a method may include some indication in reference to certain steps. However, the indication used is only to be viewed for identification purposes and not as a suggestion as to an order for the steps.

Finally, it is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. An inkjet ink, comprising:
a solvent;
a plurality of carbon nanotubes disposed in the solvent;
a binder; and
a plurality of precious metal ions adhered to a surface of each of the carbon nanotubes via the binder.

2. The inkjet ink as claimed in claim 1, wherein the binder combines the precious metals ions in the inkjet ink to generate a complex, the complex is entangled in the surface of the carbon nanotubes to cause the precious metal ions to attach to the surface of each of the carbon nanotubes uniformly.

3. The inkjet ink as claimed in claim 1, wherein the carbon nanotubes are chemically functionalized carbon nanotubes, and a plurality of functional groups is disposed on the surface of the carbon nanotubes.

4. The inkjet ink as claimed in claim 3, wherein the functional groups are hydrophilic groups selected from the group consisting of carboxyl (—COOH), aldehyde group (—CHO), amino (—NH2), hydroxyl (—OH), and combinations thereof.

5. The inkjet ink as claimed in claim 1, wherein in the inkjet ink, a weight percentage of the carbon nanotubes is in a range from about 0.2 weight percent (wt %) to about 5 wt %, a weight percentage of the precious metal ions is in a range from about 1 wt % to about 55 wt %, a weight percentage of the solvent is in a range from about 50 wt % to about 80 wt %, a weight percentage of the binder is in a range from about 0.1 wt % to about 30 wt %.

6. The inkjet ink as claimed in claim 5, wherein the inkjet ink further comprises a viscosity modifier, a surfactant, and a moisturizing agent; a weight percentage of the viscosity modifier is in a range from about 0.1 wt % to about 30 wt %, a weight percentage of the surfactant is in a range from about 0.1 wt % to about 5 wt %, and a weight percentage of the moisturizing agent of 0.1 is in a range from about 0.1 wt % to about 40 wt %.

7. The inkjet ink as claimed in claim 1, wherein the precious metal ions is selected from the group consisting of gold ions (Au⁺), silver ions (Ag⁺), palladium ions (Pd⁺), and platinum ions (Pt⁺).

8. The inkjet ink as claimed in claim 1, wherein the binder is selected from the group consisiting of polyvinyl pyrrolidones (PVP), polyvinyl alcohols (PVA), polyethyleneimine, and combinations thereof.

9. The inkjet ink as claimed in claim 1, wherein the solvent is de-ionized water.

10. A method for making conductive wires, the method comprising:
(a) providing an inkjet ink comprising a plurality of carbon nanotubes, a binder, a solvent, and a plurality of precious metal ions adhered to a surface of each of the carbon nanotubes via the binder;
(b) forming a baseline using the inkjet ink on a substrate, the baseline comprising the carbon nanotubes and the precious metal ions;
(c) reducing the precious metal ions into precious metal nanoparticles; and
(d) treating the baseline with a metalized surface treatment method.

11. The method as claimed in claim 10, wherein in the inkjet ink, a weight percentage of the carbon nanotubes is in a range from about 0.2 weight percent (wt %) to about 5 wt %, a weight percentage of the precious metal ions is in a range from about 1 wt % to about 50% wt, a weight percentage of the solvent is in a range from about 50 wt % to about 80 wt %, a weight percentage of the binder is in a range from about 0.1 wt % to about 30 wt %.

12. The method as claimed in claim 11, wherein the inkjet ink further comprises a viscosity modifier, a surfactant, and a moisturizing agent; a weight percentage of the viscosity modifier is in a range from about 0.1 wt % to about 30 wt %, a weight percentage of the surfactant is in a range from about 0.1 to about 5 wt %, a weight percentage of the moisturizing agent is in a range from about 0.1 to about 40 wt %.

13. The method as claimed in claim 10, wherein the binder combines the precious metals ions in the inkjet ink to generate a complex, the complex is entangled in the surface of the carbon nanotubes to cause the precious metal ions to attach to the surface of each of the carbon nanotubes uniformly.

14. The method as claimed in claim 10, wherein the step (a) comprises:
(a1) providing the binder and the solvent containing precious metal ions to form a first mixture;
(a2) dispersing the plurality of carbon nanotubes in the first mixture to form a second mixture;
(a3) adding a viscosity modifier, a surfactant, and the binder into the second mixture to form a third mixture, and agitating the third mixture to obtain an inkjet ink.

15. The method as claimed in claim 14, wherein in step (a1), the molar concentration ratio of the precious metal ions and the binder is in a range from about 1:100 to about 1:3.

16. The method as claimed in claim 10, wherein the baseline is formed by a method of printing.

17. The method as claimed in claim 10, wherein in step (c), the precious ions is reduced by radiation, the radiation source is ultraviolet light, laser, or gamma ray.

18. The method as claimed in claim 10, wherein the step (d) comprises:
(d1) providing a chemical plating solution; and
(d2) applying the chemical plating solution on the baseline.

19. A method for making conductive wires, the method comprising:
(a) providing an inkjet ink comprising a plurality of carbon nanotubes, a binder, a solvent, and a plurality of precious metal ions bound to a surface of each of the carbon nanotubes via the binder;
(b) forming a baseline using the inkjet ink on a substrate, the baseline comprising the carbon nanotubes and the precious metal ions;
(c) reducing the precious metal ions into precious metal nanoparticles; and
(d) electroplating the baseline.
